(19) United States
(12) Patent Application Publication
(10) Pub. No.: US 2011/0093521 A1
(43) Pub. Date: Apr. 21, 2011

(54) System and method for broadcasting content items to client devices in an electronic network

(75) Inventors: Nikolaos Georgis, San Diego, CA (US); Fredrik Carpio, San Diego, CA (US); Milton Frazier, San Marcos, CA (US)

(73) Assignees: Sony Corporation; Sony Electronics Inc.

(21) Appl. No.: 12/589,293

(22) Filed: Oct. 21, 2009

(51) Int. Cl. G06F 15/16

(52) U.S. Cl. 709/203

(57) ABSTRACT

A system and method for supporting content distribution in an electronic network includes a high-power wireless transmitter that broadcasts content items received from a content source to target devices that are configured in a peer-to-peer network. An electronic device may obtain current storage locations of a required one of the content items from a tracking server via a back channel. The electronic device may then generate a content request to at least one of said target devices in the peer-to-peer network for accessing the required one of the content items.

### BACKGROUND SECTION

1. Field of the Invention

This invention relates generally to techniques for managing electronic information, and relates more particularly to a system and method for broadcasting content items to client devices in an electronic network.

2. Description of the Background Art

Implementing effective methods for managing electronic information is a significant consideration for designers and manufacturers of contemporary electronic devices. However, effectively managing information utilized by devices in an electronic network may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced data management operations may provide additional benefits to a system user, but may also place increased demands on the control and management of various system components. For example, an enhanced electronic network device that effectively manages electronic content information may benefit from an effective implementation because of the large amount and complexity of the digital data involved.

Due to growing demands on system resources and substantially increasing data magnitudes, it is apparent that developing new techniques for managing information in electronic networks is a matter of concern for related electronic technologies. Therefore, for all the foregoing reasons, developing effective techniques for managing information in electronic networks remains a significant consideration for designers, manufacturers, and users of contemporary electronic devices.

### SUMMARY

In accordance with the present invention, a system and method for supporting content distribution in an electronic network are disclosed. In one embodiment, a tracking server or other appropriate entity initially selects a content item for broadcasting to one or more client devices in a peer-to-peer network. The selected content item is provided to a transmitter for performing a content transmission procedure. The transmitter may be implemented in any effective manner. For example, in certain embodiments, the transmitter wirelessly broadcasts electronic information to client devices in accordance with known or enhanced standards from an Advanced Television Standards Committee (ATSC).

The transmitter then performs a multicasting procedure to broadcast the selected content item to certain of the client devices that each utilize a respective receiver and download manager to receive and locally store the transmitted content item. The receiving client devices may utilize respective feedback modules to provide feedback information to the tracking server regarding currently locations of the broadcast content item in the peer-to-peer network.

A given device user of a corresponding client device may wish to utilize a the transmitted content item. The client device may determine whether the desired content item is currently stored on the device user's client device. If the desired content item is not stored on the client device, then a peer-to-peer module of the client device sends a location request to the tracking server which responsively provides one or more content locations to the requesting client device.

Based upon the received content location(s), the peer-to-peer module of the client device sends a content request to a peer client device from the peer-to-peer network that currently has the desired content item. The peer client device may then provide the requested content item to the requesting client device for appropriate utilization by the device user. For at least the foregoing reasons, the present invention therefore provides an improved system and method for effectively supporting a content distribution procedure in an electronic network.

### BRIEF DESCRIPTION OF THE DRAWINGS

FIG. 1A is a block diagram of an electronic network, in accordance with one embodiment of the present invention;

FIG. 1B is a block diagram of the peer-to-peer network of FIG. 1A, in accordance with one embodiment of the present invention;

FIG. 1C is a block diagram of the transmitter of FIG. 1A, in accordance with one embodiment of the present invention;

FIG. 1D is a block diagram of the transmitter memory of FIG. 1C, in accordance with one embodiment of the present invention;

FIG. 2 is a block diagram for one embodiment of the tracking server of FIG. 1A, in accordance with the present invention;

FIG. 3 is a block diagram for one embodiment of the server memory of FIG. 2, in accordance with the present invention;

FIG. 4 is a block diagram of exemplary content items from FIG. 3, in accordance with one embodiment of the present invention;

FIG. 5 is a block diagram for one embodiment of a client device from FIG. 1A, in accordance with the present invention;

FIG. 6 is a block diagram for one embodiment of the device memory of FIG. 5, in accordance with the present invention; and

FIGS. 7A and 7B are a flowchart of method steps for supporting a content distribution procedure, in accordance with one embodiment of the present invention.

### DETAILED DESCRIPTION

The present invention relates to an improvement in electronic information management techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Therefore, the present invention is not intended to be limited to the embodiments shown, but is to be accorded the widest scope consistent with the principles and features described herein.

The present invention comprises a system and method for supporting content distribution in an electronic network, and includes a high-power wireless transmitter that broadcasts content items received from a content source to target devices that are configured in a peer-to-peer network. An electronic device may obtain current storage locations of a required one of the content items from a tracking server via a back channel. The electronic device may then generate a content request to at least one of said target devices in the peer-to-peer network for accessing the required one of the content items.

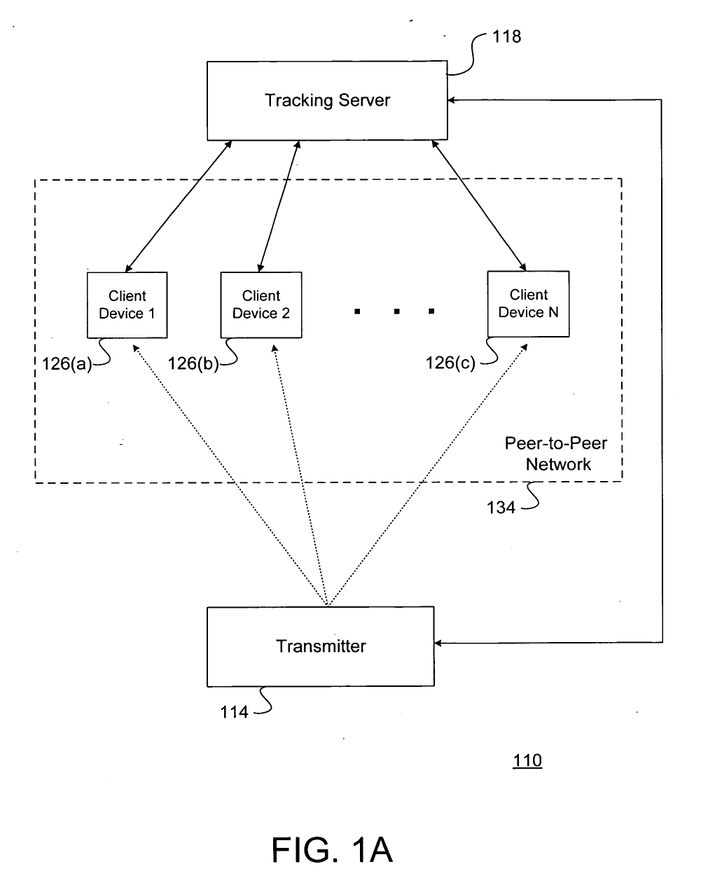

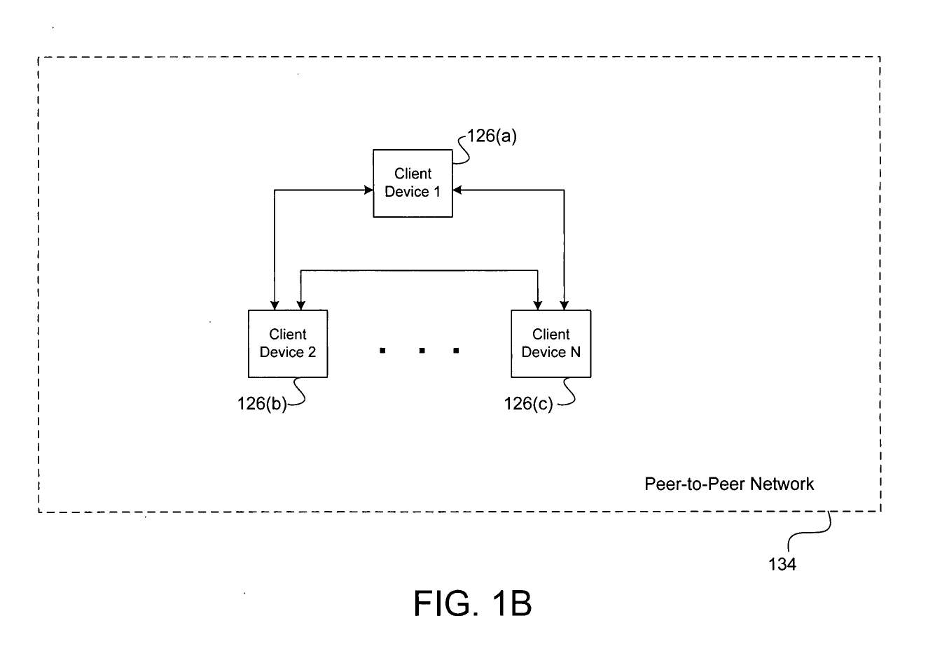

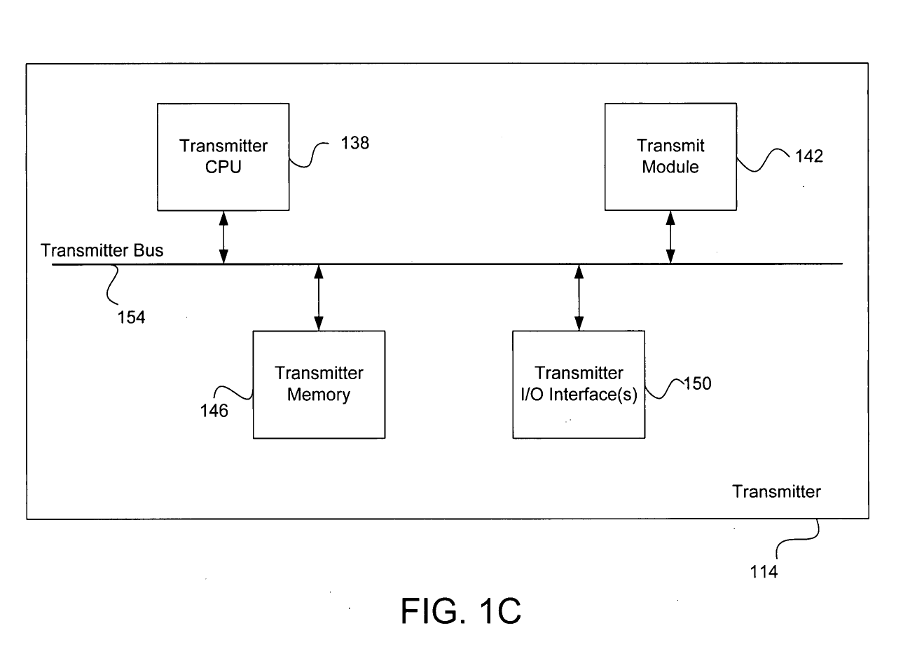

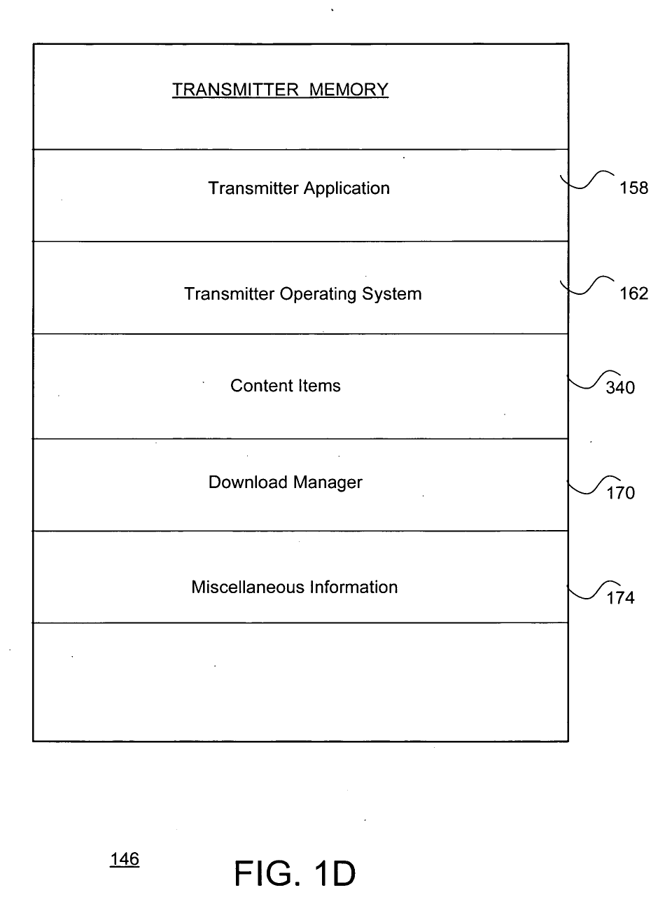

Referring now to FIG. 1A, a block diagram of an electronic network 110 is shown, in accordance with one embodiment of the present invention. In the FIG. 1A embodiment, electronic network 110 may include, but is not limited to, a transmitter 114, a tracking server 118, and a plurality of client devices 126. In alternate embodiments, electronic network 110 may be implemented by utilizing components and configurations in addition to, or instead of, certain of those components and configurations discussed in conjunction with the FIG. 1A embodiment.

In accordance with one embodiment of the present invention, any desired number of client devices 126 may be configured in a peer-to-peer network 134 that is further discussed below in conjunction with FIG. 1B. In the FIG. 1A embodiment, client devices 126 may include an electronic device 1 (126(a)) through an electronic device N 126(c). In the FIG. 1A embodiment, each of the client devices 126 may bi-directionally communicate directly with other ones of the client devices 126 by utilizing any appropriate peer-to-peer communication techniques or other effective communication methods.

In accordance with the present invention, transmitter 114 may received one or more content items from any appropriate content source. For example, transmitter 114 may receive content items, from tracking server 118 or another appropriate entity. The content items may include any desired types of electronic information. For example, content items may include, but are not limited to, entertainment programming, movies, video data, audio data, digital photographs, still image data, graphics, web pages, program guide information, and various types of software programs, etc.

In the FIG. 1A embodiment, transmitter 114 may then perform a multicast procedure to simultaneously broadcast a unidirectional data stream that includes one or more appropriate content items or content segments to a plurality of the client devices 126. In the FIG. 1A embodiment, transmitter 114 may be implemented as a high-power wireless radio-frequency transmitter device that has a transmission range of approximately fifty miles or more, depending upon the selected operating frequency and operating power.

In the FIG. 1A embodiment, tracking server 118 continually performs a content-location monitoring procedure to determine and store specific content locations for content items on the various client devices 126. In certain embodiments, after receiving a given content item, the client devices 126 provide feedback information via a back channel to tracking server 118 for updating the content locations of the various content items. The back channel may include any effective communication path between the client devices 126 and tracking server 118. In certain embodiments, the back channel may include, but is not limited to, Internet connections between respective client devices 126 and tracking server 118.

In accordance with one embodiment of the present invention, if a given client device 126 requires some or all of a particular content item that has already been broadcast by transmitter 114, the client device 126 may obtain from tracking server 118 one or more appropriate content locations in peer-to-peer network 134 for obtaining the desired content item or content segment. The client device 126 may then request and download the content item or content segment through peer-to-peer network 134 from another peer client device 126. In addition, in certain embodiments, the client device 126 may alternately request a download of the desired content item or content segment directly from tracking server 118 or other appropriate content source through the back channel. Additional details regarding these content distribution procedures are further discussed below in conjunction with FIGS. 1B-7B.

Referring now to FIG. 1B, a block diagram of the FIG. 1A peer-to-peer network 134 is shown, in accordance with one embodiment of the present invention. The FIG. 1B embodiment includes a client device 1 (126(a)), a client device 2 (126(b)), through a client device N (126(a)). In alternate embodiments, peer-to-peer network 134 may be implemented by utilizing components and configurations in addition to, or instead of, certain of those components and configurations discussed in conjunction with the FIG. 1B embodiment. Furthermore, peer-to-peer network 134 may be implemented to include any desired number of client devices 126.

In the FIG. 1B embodiment, each of the client devices 126 may bi-directionally communicate directly with any other of the client devices 126 by utilizing any desired peer-to-peer communication techniques or other effective communication methods. For example, client device 1 (126(a)) may bi-directionally communicate directly with either client device 2 (126(b)) or client device N (126(c)). Similarly, client device 2 (126(b) may bi-directionally communicate directly with client device N (126(c)). Furthermore, in the FIG. 1B embodiment, any of the client devices 126 in peer-to-peer network 134 may perform a peer-to-peer content transfer procedure to transfer content items or content segments to any of the other client devices 126 in peer-to-peer network 134. Additional details regarding the utilization of the FIG. 1B peer-to-peer network 134 are further discussed below in conjunction with FIGS. 1C-7B.

Referring now to FIG. 1C, a block diagram for one embodiment of the FIG. 1A transmitter 114 is shown, in accordance with the present invention. In the FIG. 1C embodiment, transmitter 114 includes, but is not limited to, a transmitter central processing unit (transmitter CPU) 138, a transmit module 142, a transmitter memory 146, and one or more transmitter input/output interface(s) (transmitter I/O interface(s)) 150. The foregoing components of transmitter 114 may be coupled to, and communicate through, a transmitter bus 154. In alternate embodiments, transmitter 114 may alternately be implemented using components and configurations in addition to, or instead of, certain of those components and configurations discussed in conjunction with the FIG. 1C embodiment.

In the FIG. 1C embodiment, transmitter CPU 138 may be implemented to include any appropriate and compatible microprocessor device that preferably executes software instructions to thereby control and manage the operation of transmitter 114. The FIG. 1C transmitter 114 may utilize transmit module 142 to send electronic information to one or more electronic devices 126 (FIG. 1A) by utilizing any effective type of wireless or wired communication techniques. For example, in certain embodiments, transmitter 114 may include a commercial television broadcast transmitter. Furthermore, in certain embodiments, transmitter 114 may be implemented to broadcast electronic information according to known or enhanced standards from the Advanced Television Standards Committee (ATSC).

In the FIG. 1C embodiment, transmitter memory 146 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of transmitter memory 146 are further discussed below in conjunction with FIG. 1D.

In the FIG. 1C embodiment, transmitter I/O interface(s) 150 may include one or more input and/or output interfaces to receive and/or transmit any required types of information by transmitter 114. Transmitter I/O interface(s) 150 may include one or more means for allowing a transmitter user to communicate with transmitter 114. In the FIG. 1C embodiment, transmit module 142 may include any appropriate technologies to support broadcasts from transmitter 114 to client devices 126 (FIG. 1A). For example, in certain embodiments, transmit module 142 may include a high-voltage transmission power supply, radio-frequency transmitter hardware components, and a broadcasting antennae array that is mounted on an elevated broadcasting tower to support long-range wireless multicasts to client devices 126. The implementation and utilization of transmitter 114 is further discussed below in conjunction with FIGS. 1D-7B.

Referring now to FIG. 1D, a block diagram for one embodiment of the FIG. 1C transmitter memory 146 is shown, in accordance with the present invention. In the FIG. 1D embodiment, transmitter memory 146 may include, but is not limited to, a transmitter application 158, a transmitter operating system 162, one or more content items 340, a download manager 170, and miscellaneous information 174. In alternate embodiments, transmitter memory 146 may include various other components and functionalities in addition to, or instead of, certain those components and functionalities discussed in conjunction with the FIG. 1D embodiment.

In the FIG. 1D embodiment, transmitter application 158 may include program instructions that are preferably executed by transmitter CPU 138 (FIG. 1C) to perform various functions and operations for transmitter 114. The particular nature and functionality of transmitter application 158 typically varies depending upon factors such as the specific type and particular functionality of the corresponding transmitter 114. Transmitter operating system 162 may perform various low-level functions for transmitter 114.

In the FIG. 1D embodiment, content items 340 may include any appropriate type of content items or other information received by transmitter application 158 from tracking server 118 (FIG. 1A) or other appropriate entity. For example, in certain embodiments, content items 340 may include, but are not limited to, any types of entertainment programming, movies, video data, audio data, digital photographs, still image data, graphics, web pages, program guide information, and various types of software programs, etc.

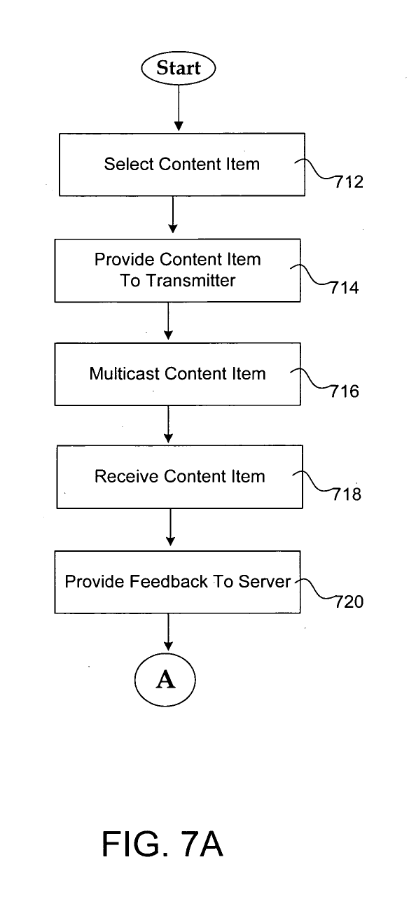

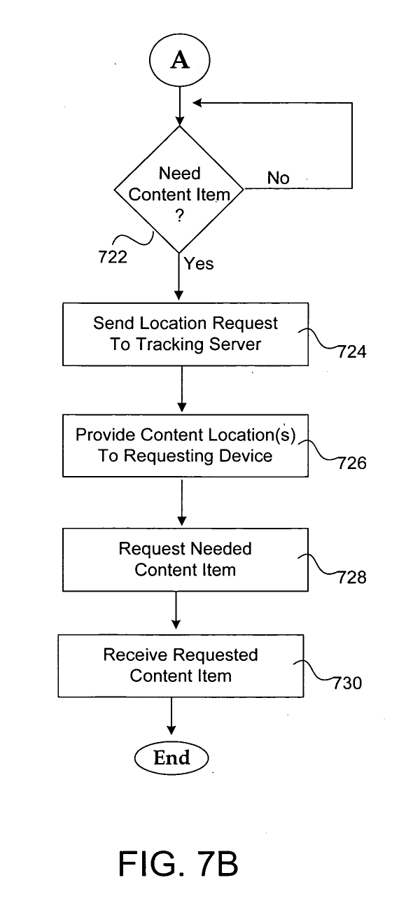

In the FIG. 1D embodiment, download manager 170 may be utilized to coordinate content transmission procedures, in accordance with the present invention. In the FIG. 1D embodiment, miscellaneous information 174 may include any appropriate additional information or data that is required by transmitter 114. Additional details regarding the operation of download manager 170 are further discussed below in conjunction with FIG. 7.

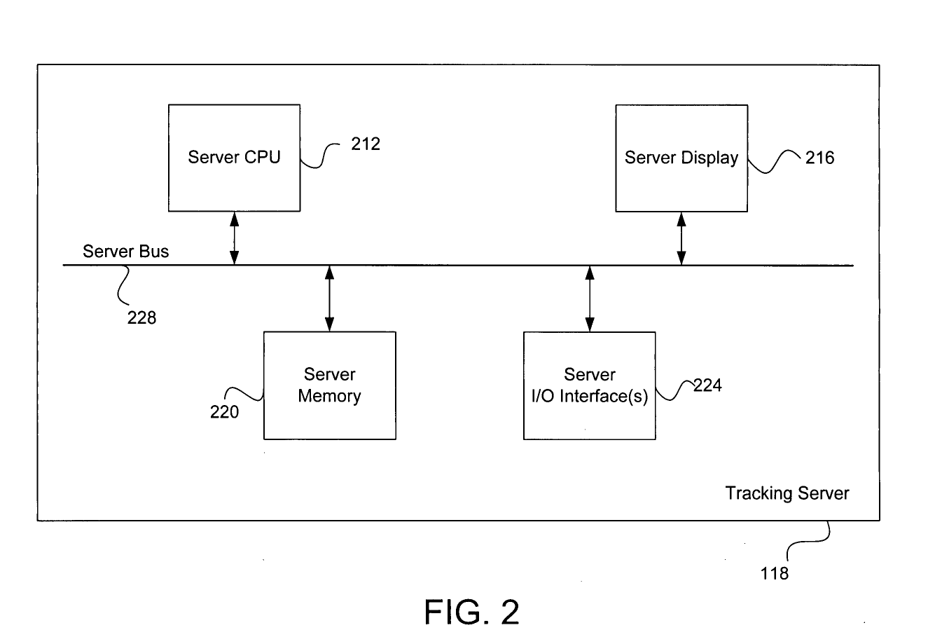

Referring now to FIG. 2, a block diagram for one embodiment of the FIG. 1A tracking server 118 is shown, in accordance with the present invention. In the FIG. 2 embodiment, tracking server 118 includes, but is not limited to, a server central processing unit (server CPU) 212, a server display 216, a server memory 220, and one or more server input/output interface(s) (server I/O interface(s)) 224. The foregoing components of tracking server 118 may be coupled to, and communicate through, a server bus 228. In alternate embodiments, tracking server 118 may alternately be implemented using components and configurations in addition to, or instead of, certain of those components and configurations discussed in conjunction with the FIG. 2 embodiment.

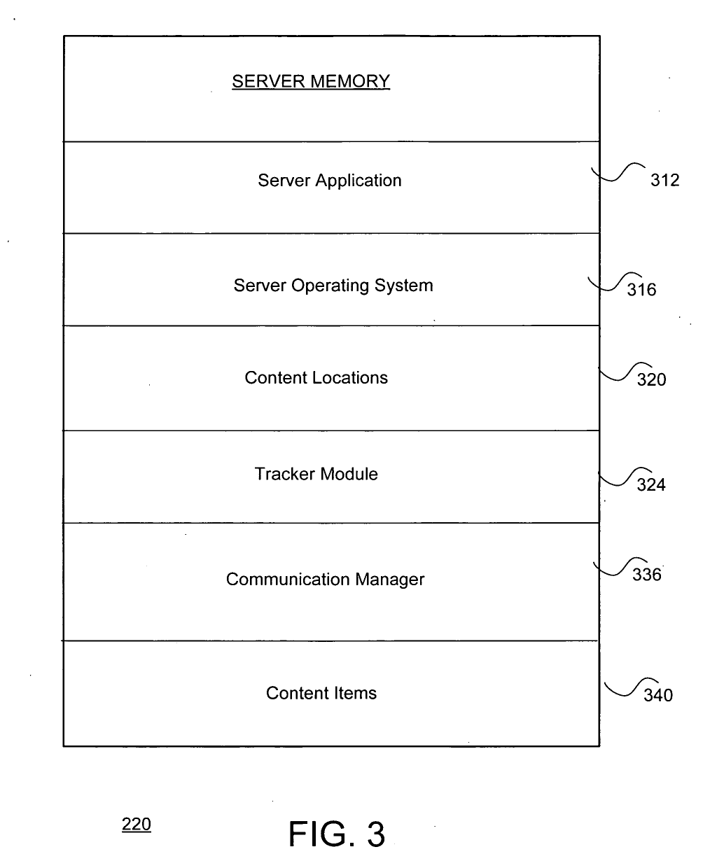

In the FIG. 2 embodiment, server CPU 212 may be implemented to include any appropriate and compatible microprocessor device that preferably executes software instructions to thereby control and manage the operation of tracking server 118. The FIG. 2 server display 216 may include any effective type of display technology including a cathode-ray-tube monitor or a liquid-crystal display device with an appropriate screen for displaying various information to a server user. In the FIG. 2 embodiment, server memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of server memory 220 are further discussed below in conjunction with FIG. 3.

In the FIG. 2 embodiment, server I/O interface(s) 224 may include one or more input and/or output interfaces to receive and/or transmit any required types of information by tracking server 118. Server I/O interface(s) 224 may include one or more means for allowing a server user to communicate with tracking server 118. The utilization of tracking server 118 is further discussed below in conjunction with FIGS. 3-4 and 7.

Referring now to FIG. 3, a block diagram for one embodiment of the FIG. 2 server memory 220 is shown, in accordance with the present invention. In the FIG. 3 embodiment, server memory 220 may include, but is not limited to, a server application 312, a server operating system 316, content locations 320, a tracker module 324, a communication manager 336, and content items 340. In alternate embodiments, server memory 220 may include various other components and functionalities in addition to, or instead of, certain those components and functionalities discussed in conjunction with the FIG. 3 embodiment.

In the FIG. 3 embodiment, server application 312 may include program instructions that are preferably executed by server CPU 212 (FIG. 2) to perform various functions and operations for tracking server 118. The particular nature and functionality of server application 312 typically varies depending upon factors such as the specific type and particular functionality of the corresponding tracking server 118. Server operating system 316 may perform various low-level functions for tracking server 118.

In the FIG. 3 embodiment, content locations 320 may include any appropriate type of tracking information to specify or track the current locations of individual content items on client devices 126 (FIG. 1A). In certain embodiments, content locations 320 may include unique content identifiers that are associated with corresponding client device identifiers that represent the respective client devices 126 on which the content items are stored.

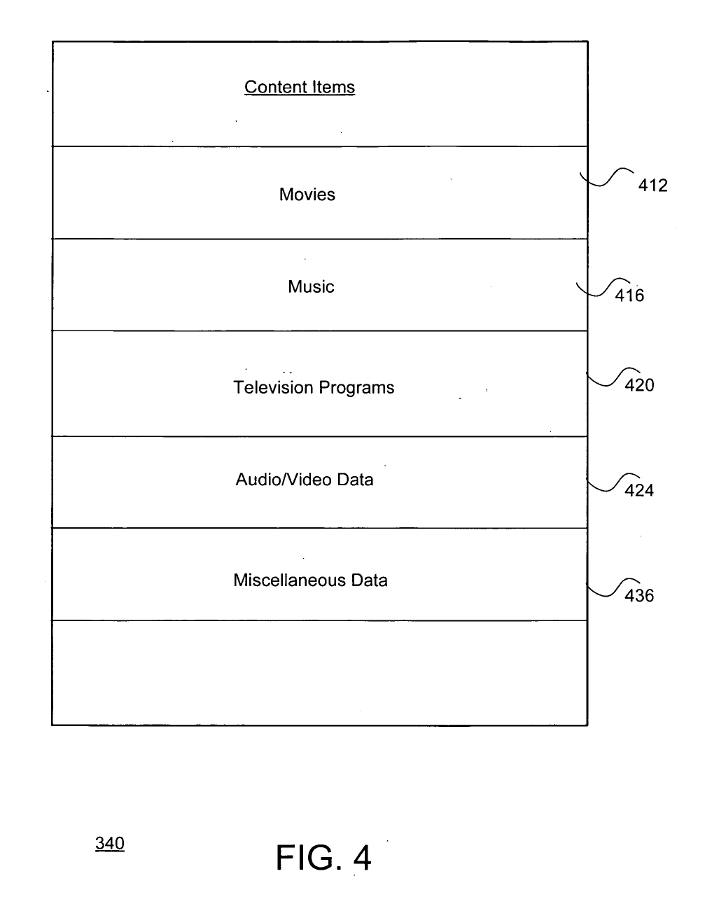

In the FIG. 3 embodiment, tracker module 324 may monitor any transfers of content items between the various client devices 126. Tracker module 324 may then dynamically update content locations 320 to incorporate any new changes in the current storage locations of the various content items on client devices 126. Furthermore, tracker module 324 may also update content locations 320 to indicate client devices 126 that have received content items as a result of a multicast from transmitter 114 (FIG. 1A). In the FIG. 3 embodiment, communication manager 336 may perform appropriate communication functions with client devices 126 to transfer requested content locations 320 and other desired information. In the FIG. 3 embodiment, content items 340 may include supported content and other information for providing to transmitter 114 for broadcast to client devices 126. Additional details regarding the operation and implementation of tracking server 118 are further discussed below in conjunction with FIGS. 4 and 7.

Referring now to FIG. 4, a block diagram for one embodiment of the FIG. 3 content items 340 is shown, in accordance with the present invention. In the FIG. 4 embodiment, content items 340 include, but are not limited to, movies 412, music 416, television programs 420, audio/video data 424, and miscellaneous data 436. In the FIG. 4 embodiment, content items 320 are presented for purposes of illustration. In alternate embodiments, tracking server 118 may utilize transmitter 114 to broadcast various content items 340 that include elements and information in addition to, or instead of, certain of those elements and information discussed in conjunction with the FIG. 4 embodiment.

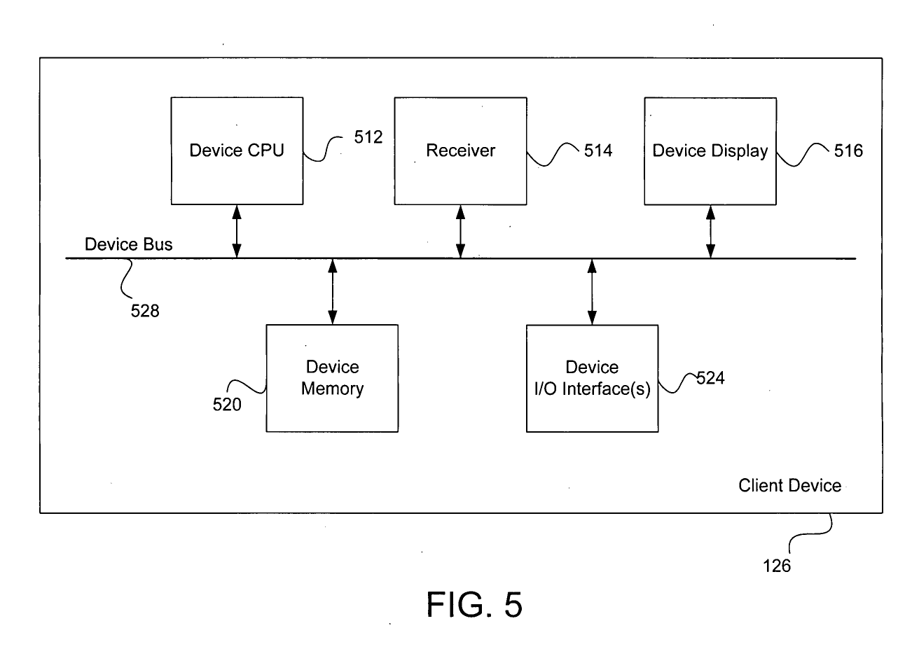

In the FIG. 4 embodiment, movies 412, music 416, television programs 420, and audio/video data 424 may include various types of electronic information from any appropriate data source(s). Miscellaneous data 436 may include any additional information for utilization by server 118 or client devices 126 The transmission and reception of content items 320 is further discussed below in conjunction with FIGS. 5-7.

Referring now to FIG. 5, a block diagram for one embodiment of a FIG. 1A client device 126 is shown, in accordance with the present invention. In the FIG. 5 embodiment, client device 126 may include, but is not limited to, a device central processing unit (device CPU) 512, a receiver 514, a device display 516, a device memory 520, and one or more device input/output interface(s) (device I/O interface(s)) 524. The foregoing components of client device 126 may be coupled to, and communicate through, a device bus 528.

In alternate embodiments, client device 126 may readily be implemented using various components and configurations in addition to, or instead of, certain of those components and configurations discussed in conjunction with the FIG. 5 embodiment. Furthermore, in the FIG. 5 embodiment, client device 126 may be implemented as any type of appropriate electronic device. For example, in certain embodiments, client device 126 may be implemented as any type of stationary or portable electronic device, such as a personal computer, a television, a consumer-electronics device, a cellular telephone, a settop box, an audio-visual entertainment device, or a personal digital assistant (PDA).

In the FIG. 5 embodiment, device CPU 512 may be implemented to include any appropriate and compatible microprocessor device that preferably executes software instructions to thereby control and manage the operation of client devices 126. In the FIG. 5 embodiment, receiver 514 may include any effective means of receiving broadcasts or transmissions from an external entity. For example, receiver 514 may be configured to wirelessly receive transmissions from transmitter 114, as discussed above in conjunction with FIG. 1A.

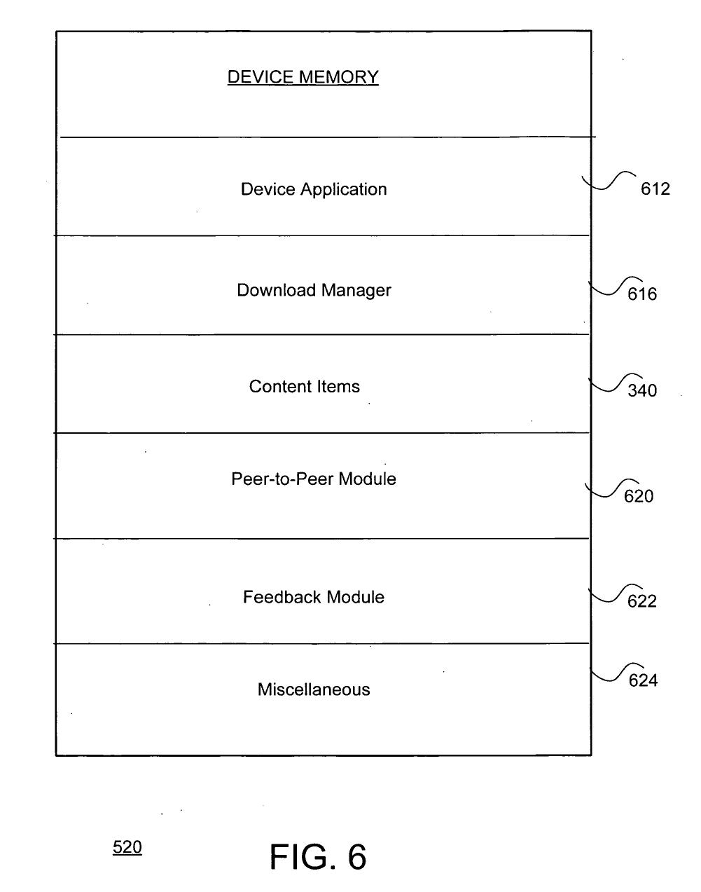

The FIG. 5 device display 516 may include any effective type of display technology including a cathode-ray-tube monitor or a liquid-crystal display device with an appropriate screen for displaying various information to a device user. In the FIG. 5 embodiment, device memory 520 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of device memory 520 are further discussed below in conjunction with FIG. 6.

In the FIG. 5 embodiment, device I/O interface(s) 524 may include one or more input and/or output interfaces to receive and/or transmit any required types of information by client device 126. Device I/O interface(s) 524 may include one or more means for allowing a device user to communicate with other entities in electronic network 110 (FIG. 1A). For example, the foregoing means may include a keyboard device, a wireless remote-control device, a speech-recognition module with corresponding microphone, a graphical user interface with touch-screen capability, a hand-held device controller unit, or a selection button array mounted externally on client device 126. The implementation and utilization of client device 126 are further discussed below in conjunction with FIGS. 6-7.

Referring now to FIG. 6, a block diagram for one embodiment of the FIG. 5 device memory 520 is shown, in accordance with the present invention. In the FIG. 6 embodiment, device memory 520 includes, but is not limited to, a device application 612, a download manager 616, content items 340, a peer-to-peer module 620, a feedback module 622, and miscellaneous items 624. In alternate embodiments, device memory 520 may include components and functionalities in addition to, or instead of, certain of those components and functionalities discussed in conjunction with the FIG. 6 embodiment.

In the FIG. 6 embodiment, device application 612 may include program instructions that are preferably executed by a device CPU 512 (FIG. 5) to perform various functions and operations for a client device 126. The particular nature and functionality of device application 612 typically varies depending upon factors such as the specific type and particular functionality of the corresponding client device 126.

In the FIG. 6 embodiment, download manager 616 may perform communication procedures for exchanging electronic information with external entities by utilizing any appropriate techniques. For example, download manager 616 may coordinate content download procedures to automatically receive and locally store broadcasted content items 340 from transmitter 114 (FIG. 1A). In the FIG. 6 embodiment, content items 340 may include either content that was broadcast from transmitter 114, or content that was received from other client devices 126.

In the FIG. 6 embodiment, peer-to-peer module 620 may be utilized by a particular client device 126 to directly communicate with any other client device 126 in peer-to-peer network 134 (FIG. 1B). For example, peer-to-peer module 620 may perform a content transfer procedure to obtain downloaded content items or content segments from other client devices 126 in peer-to-peer network 134. In the FIG. 6 embodiment, feedback module 622, may communicate with tracking server 118 (FIG. 1A) or other appropriate entity to provide content location information for content items 618 on client device 126. Miscellaneous information 624 may include any additional information that for utilization by client device 126. The utilization and implementation of client device 126 is further discussed below in conjunction with FIG. 7.

Referring now to FIGS. 7A and 7B, a flowchart of method steps for supporting a content distribution procedure is shown, in accordance with one embodiment of the present invention. The FIG. 7 flowchart is presented for purposes of illustration, and in alternate embodiments, the present invention may utilize steps and sequences other than those steps and sequences discussed in conjunction with the FIG. 7 embodiment.

In step 712 of FIG. 7A, a tracking server 118 or other appropriate entity initially selects a content item 340 for broadcasting to one or more client devices 126 in a peer-to-peer network 134. In step 714, the selected content item 340 is provided to a transmitter 114 for transmission. The transmitter 114 may be implemented in any effective manner. For example, in certain embodiments, the transmitter 114 wirelessly broadcasts electronic information unidirectionally to client devices 126 in accordance with known or enhanced standards from an Advanced Television Standards Committee (ATSC).

In step 716, the transmitter 114 performs a multicasting procedure to broadcast the selected content item 340 to the client devices 126. In step 718, certain of the client devices 126 utilize a receiver 514 and a download manager 616 to receive and locally store the transmitted content item 340. In step 720, the client devices 126 utilize respective feedback modules 622 to provide feedback information to the tracking server 118 regarding currently locations of the broadcast content item 340 in the peer-to-peer network 134. The FIG. 7A process then advances to step 722 of FIG. 7B through connecting letter “A.”

In step 722, a device user of a given client device 126 may determine whether the broadcasted content item 340 is needed because the content item 340 is not currently stored on the client device 126. If content item 340 is needed, then in step 724, a peer-to-peer module 620 of the client device 126 sends a location request to the tracking server 118. In step 726, the tracking server 118 responsively provides one or more content locations 320 for the content item 340 to the requesting client device 126.

In step 728, the peer-to-peer module 620 of the client device 126 then sends a content request to a peer client device 126 that currently has the desired content item 340. In step 730, the peer client device 126 then provides the requested content item 340 to the requesting client device 126. The FIG. 7 process may then terminate. For at least the foregoing reasons, the present invention therefore provides an improved system and method for effectively supporting a content distribution procedure in an electronic network.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for supporting content distribution in an electronic network, comprising:
a transmitter that broadcasts content items received from a content source;
target devices that receive said content items from said transmitter; and
an electronic device that generates a content request to at least one of said target devices for accessing a required one of said content items.

2. The system of claim 1 further comprising a tracking server from which said electronic device obtains current storage locations of said required one of said content items, said current storage locations specifically identifying said target devices to said electronic device.

3. The system of claim 1 wherein said transmitter is implemented as a high-power wireless transmitter device that broadcasts said content items according to transmission standards that are defined by an Advanced Television Systems Committee.

4. The system of claim 2 wherein said electronic device provides feedback information to said tracking server after said electronic device receives said required one of said content items, said feedback information including a current location on said electronic device of said required one of said content items.

5. The system of claim 1 wherein said target devices and said electronic device are configured in a peer-to-peer network that supports direct bi-directional communications between said electronic device and any of said client devices.

6. The system of claim 1 wherein said target devices and said electronic device are implemented as personal computer devices.

7. The system of claim 1 wherein said content items include entertainment programming, movies, video data, audio data, digital photographs, still image data, graphics, web pages, program guide information, and software programs.

8. The system of claim 2 wherein said electronic device sends a location request to said tracking server through a back channel over an Internet network, a tracker module of said tracking server returning said current storage locations to said electronic device to specifically locate said required one of said content items.

9. The system of claim 8 wherein said electronic device sends said content request to said target devices that were identified by said tracking server as currently storing said required one of said content items.

10. The system of claim 9 wherein said electronic device receives said required one of said content items from one of said target devices through a peer-to-peer network.

11. An electronic device for supporting a content distribution procedure in an electronic network, comprising:
a download manager that is configured to receive content items that are broadcast from a transmitter; and
a peer-to-peer module that generates a content request to one or more target devices for accessing a required one of said content items that were not received from said transmitter.

12. The electronic device of claim 11 wherein said electronic device obtains current storage locations of said required one of said content items from a tracking server, said current storage locations specifically identifying said target devices to said electronic device.

13. The electronic device of claim 11 wherein said transmitter is implemented as a high-power wireless transmitter device that broadcasts said content items according to transmission standards that are defined by an Advanced Television Systems Committee.

14. The electronic device of claim 12 wherein said electronic device provides feedback information to said tracking server after said electronic device receives said required one of said content items, said feedback information including a current location on said electronic device of said required one of said content items.

15. The electronic device of claim 11 wherein said target devices and said electronic device are configured in a peer-to-peer network that supports direct bi-directional communications between said electronic device and any of said client devices.

16. The electronic device of claim 11 wherein said target devices and said electronic device are implemented as personal computer devices.

17. The electronic device of claim 11 wherein said content items include entertainment programming, movies, video data, audio data, digital photographs, still image data, graphics, web pages, program guide information, and software programs.

18. The electronic device of claim 12 wherein said electronic device sends a location request to said tracking server through a back channel over an Internet network, a tracker module of said tracking server returning said current storage locations to said electronic device to specifically locate said required one of said content items.

19. The electronic device of claim 18 wherein said electronic device sends said content request to said target devices that were identified by said tracking server as currently storing said required one of said content items.

20. The electronic device of claim 19 wherein said electronic device receives said required one of said content items from one of said target devices through a peer-to-peer network.
